(19) United States
(12) Patent Application Publication
(10) Pub. No.: US 2008/0006484 A1
(43) Pub. Date: Jan. 10, 2008

(54) System for transferring vehicle body in vehicle assembling system

(76) Inventors: Tae Won Lim, Suwon-city (KR); Dong Hwan Yang, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,717

(22) Filed: Dec. 15, 2005

(30) Foreign Application Priority Data
Dec. 23, 2004 (KR) 10-2004-0111259

(51) Int. Cl. B66B 9/16

(52) U.S. Cl. 187/244

(57) ABSTRACT

A system for transferring a vehicle body according to an embodiment of the present invention includes a stage accommodating the vehicle body and transferring the vehicle body, and a height regulating unit which is disposed on the stage and which regulates height of the vehicle body according to a type of assembly line. The height regulating unit includes a bracket disposed on a lower portion of the stage; at least one lifter, one end of which is disposed on the bracket and the other end of which is disposed on the vehicle body, so as to raise and lower the vehicle body; and a driving part for driving the lifter.

### CROSS-REFERENCE TO RELATED APPLICATION

This application claims priority to and the benefit of Korean Patent Application No. 10-2004-0111259 filed in the Korean Intellectual Property Office on Dec. 23, 2004, the entire contents of which are incorporated herein by reference.

### BACKGROUND OF THE INVENTION

(a) Field of the Invention

The present invention relates to a vehicle assembling system, and in particular, to a system for transferring a vehicle body in a vehicle assembly line.

(b) Description of the Related Art

In general, a vehicle assembling system is for assembling parts to a vehicle body having been coated through the coating line, and it includes a trim line, a chassis line, a final line, and an o.k. line.

The trim line assembles electric wires, a ceiling, and an instrument panel, etc., to the coated vehicle body.

The chassis line assembles an engine, a muffler, and a suspension, etc., to the vehicle body having passed through the trim line.

The final line assembles tires, glass, and lamps, etc., to the vehicle body having passed through the chassis line.

A conventional conveyor for a vehicle assembling system will hereinafter be described.

The conventional vehicle assembling system includes a conveyor which is respectively provided to the trim line, the chassis line, the final line, and the o.k. line so as to transfer the vehicle body.

The chassis line is generally provided with an overhead conveyor such that a worker can see a lower portion of the vehicle so as to mount the engine, etc., to the lower portion of the vehicle. In detail, the overhead conveyor includes a rail positioned apart from the ground by a predetermined height, and a vehicle body holder slidably disposed on the rail.

The trim line and the final line are generally provided with a floor conveyor. In detail, the floor conveyor includes a rail mounted to the ground, and a vehicle body supporter slidably disposed on the rail.

However, the conventional vehicle assembling system may have the following problems.

Since a type of conveyor is varied according to each line, excessive cost and time may be required so as to establish each line.

In addition, since the floor conveyor and the overhead conveyor have a different height to each other, a separate lifter may be required so as to transfer the vehicle body from the floor conveyor to the overhead conveyor. Therefore, cost and time may be increased, and productivity may be lowered.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide a system for transferring a vehicle body having advantages of continuously transferring a vehicle body from one line to another line and automatically regulating a height of the vehicle body positioned between lines.

A system for transferring a vehicle body according to an embodiment of the present invention includes a stage accommodating the vehicle body and transferring the vehicle body, and a height regulating unit which is disposed on the stage and which regulates height of the vehicle body according to a type of assembly line. The height regulating unit includes: a bracket disposed on a lower portion of the stage; at least one lifter, one end of which is disposed on the bracket and the other end of which is disposed on the vehicle body, so as to raise and lower the vehicle body; and a driving part for driving the lifter.

In a further embodiment according to the present invention, the at least one lifter includes first and second lifters respectively disposed on left and right sides of the vehicle body so as to prevent the vehicle body from trembling left and right. The driving part includes: a motor which is disposed on a lower surface of the stage and which drives the first and second lifters at the same time; a first universal joint connected between the motor and the first lifter; and a second universal joint connected between the motor and the second lifter.

In another further embodiment according to the present invention, the first and second lifters respectively include first and second vertical elastic members that support the weight of the vehicle, and that are rolled at need; first and second rollers round which the first and second vertical elastic members are respectively rolled, and that are respectively connected to the first and second universal joints; and first and second exterior parts into which the first and second vertical elastic members are respectively inserted, and that expand and contract.

In another further embodiment according to the present invention, the height regulating unit includes first and second holding parts that are respectively mounted to ends of the first and second lifters so as to hold the vehicle body.

In another further embodiment according to the present invention, the height regulating unit further includes at least one supporter, one end of which is mounted to the bracket and the other end of which is mounted to the holding part, so as to prevent the vehicle body from trembling front and rear thereof, and the at least one supporter expands and contracts according to up and down driving directions of the lifter.

In another further embodiment according to the present invention, the at least one supporter includes first and second supporters that respectively support left and right sides of the first holding part with respect to the first lifter and third and fourth supporters that respectively support left and right sides of the second holding part with respect to the second lifter.

In another further embodiment according to the present invention, the at least one supporter includes a fifth supporter, which accommodates the first lifter and supports the first holding part, and a sixth supporter, which accommodates the second lifter and supports the second holding part.

In another further embodiment according to the present invention, the supporter is a telescopic housing in which a plurality of pipes are sequentially inserted.

### BRIEF DESCRIPTION OF THE DRAWINGS

FIG. 1 is a perspective view showing a system for transferring a vehicle body according to a first exemplary embodiment of the present invention.

FIG. 2 is a sectional view showing a principal part of FIG. 1.

FIG. 3 shows a state in which a lifter contracts, in a system for transferring a vehicle body according to the first exemplary embodiment of the present invention.

FIG. 4 is a sectional view showing a principal part of FIG. 3.

FIG. 5 is a perspective view showing a system for transferring a vehicle body according to a second exemplary embodiment of the present invention.

FIG. 6 is a perspective view showing a state in which a lifter contracts, in a system for transferring a vehicle body according to the second exemplary embodiment of the present invention.

FIG. 7 is a perspective view showing a vehicle assembling line which is applied with a system for transferring a vehicle body according to exemplary embodiments of the present invention.

### DETAILED DESCRIPTION OF THE EMBODIMENTS

Exemplary embodiments of the present invention will hereinafter be described in detail with reference to the accompanying drawings.

Description of Reference Numerals Indicating Primary Elements in the Drawings

| | |
|---|---|
| 1: vehicle body | 100: stage |
| 110: wheel | 200: height regulating unit |
| 210: bracket | C: driving part |
| 220: motor | 241: first universal joint |
| 242: second universal joint | 230: lifter |
| 231a and 232a: first and second vertical | |
| elastic members | |
| 231b and 232b: first and second rollers | |
| 231c and 232c: first and second exterior | |
| parts | |

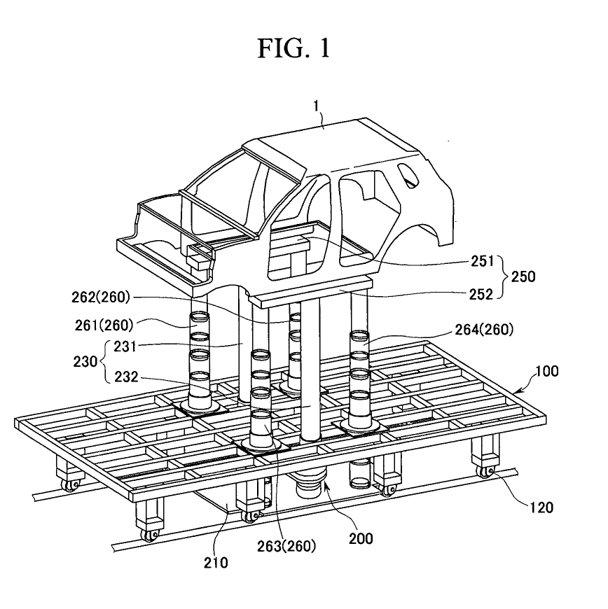

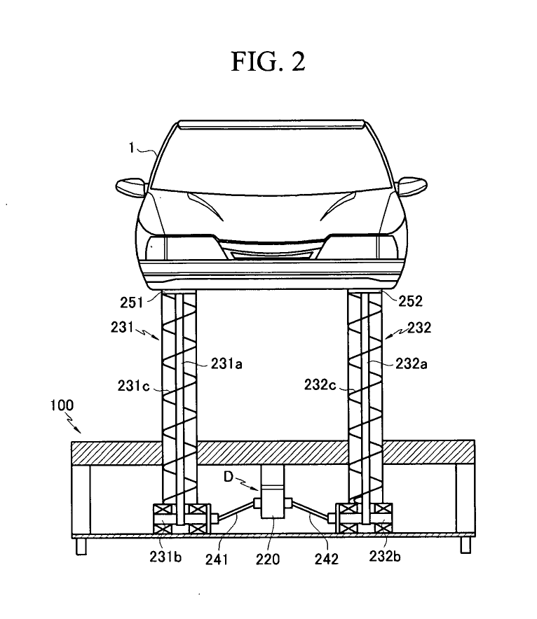

A system for transferring a vehicle body according to a first exemplary embodiment of the present invention, as shown in FIGS. 1 and 2, includes a stage 100 and a height regulating unit 200.

The vehicle is loaded onto the stage 100, and the stage 100 transfers the vehicle body 1. In addition, a plurality of wheels 120 are mounted to a lower surface of the stage 100 such that the stage 100 transfers along a rail disposed on the ground.

The height regulating unit 200 is disposed on the stage 100 and regulates the height of the vehicle body 1 according to a type of assembly line

In addition, such a height regulating unit may include a bracket 210, at least one lifter 230, and a driving part (refer to “D” in FIG. 2).

The bracket 210 is mounted to a lower potion of the stage 100.

One end of the at least one lifter 230 is disposed on the bracket 210, and the other end thereof is disposed on the vehicle body 1. Thereby, the lifter 230 raises and lowers the vehicle body 1. In more detail, the at least one lifter 230 may include first and second lifters 231 and 232 respectively disposed on left and right sides of the vehicle body 1 so as to prevent the vehicle body 1 from trembling left and right.

The driving part D supplies driving power to the lifter 230. In more detail, such a driving part D may include a motor 220, a first universal joint 241, and a second universal joint 242.

The motor 220 is disposed on a lower surface of the stage 100, and it drives the first and second lifters 231 and 232 at the same time. The first universal joint 241 is connected between the motor 220 and the first lifter 231, and the second universal joint 242 is connected between the motor 220 and the second lifter 232.

Meanwhile, the first lifter 231 may, as shown in FIG. 2, include a first vertical elastic member 231a, a first roller 231b, and a first exterior part 231c. That is, the first lifter 231 may be a spiral type lifter. In addition, the second lift 232 may also include a second vertical elastic member 232a, a second roller 232b, and a second exterior part 232c. The second lifter 232 may also be a spiral type lifter.

The first and second vertical elastic members 231a and 232a support the weight of the vehicle body 1, and they are made of a material which can be rolled. The first and second rollers 231b and 232b are respectively connected to the first and second universal joints 241 and 242, and the first and second vertical elastic members 231a and 232a are respectively rolled round the first and the second rollers 231b and 232b. The first and second exterior parts 231c and 232c are made of a material which can expand and contract, and the first and second vertical elastic members 231a and 232a are respectively inserted into the first and second exterior parts 231c and 232c.

In addition, the height regulating unit 200 may include first and second holding parts 251 and 252 that are respectively mounted to ends of the first and second lifters 231 and 232 so as to hold the vehicle body 1.

In addition, the height regulating unit 200 may further include at least one supporter 260, one end of which is mounted to the bracket 210 and the other end of which is mounted to the holding part 250, so as to prevent the vehicle body 1 from trembling front and rear thereof, and the at least one supporter 260 expands and contracts according to up and down driving directions of the lifter 230.

The at least one supporter 260 may include first and second supporters 261 and 262 that respectively support left and right sides of the first holding part 251 with respect to the first lifter 231, and third and fourth supporters 263 and 264 that respectively support left and right sides of the second holding part 252 with respect to the second lifter 232.

In particular, the first, second, third, and fourth supporters 261, 262, 263, and 264, as shown in FIG. 1, may each be a telescopic housing in which a plurality of pipes are sequentially inserted.

An operation of a system for transferring a vehicle body according to a first exemplary embodiment of the present invention will hereinafter be described in detail with reference to FIGS. 1 to 4.

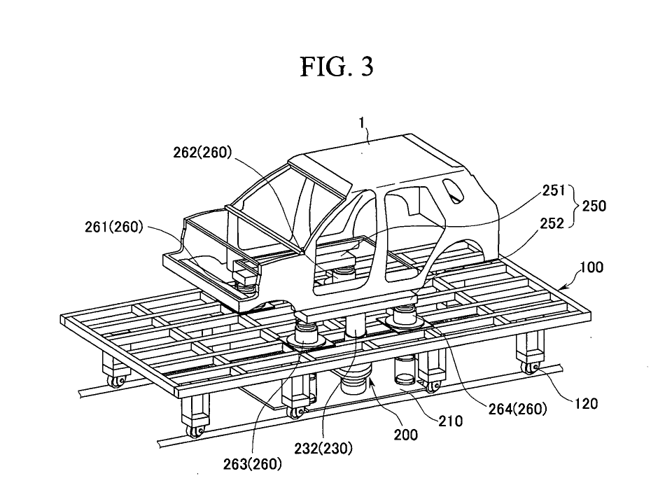

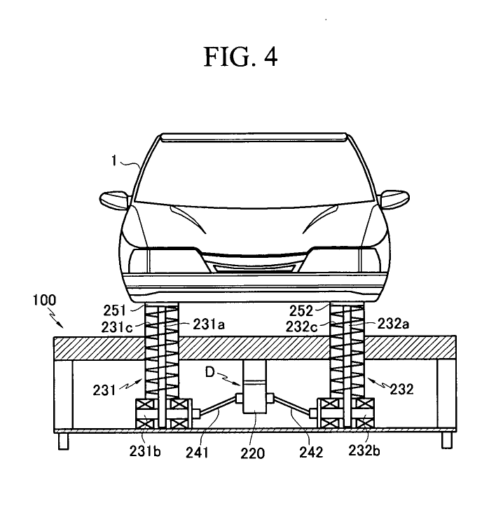

FIG. 3 shows a state in which a lifter contracts, in a system for transferring a vehicle body according to a first exemplary embodiment of the present invention. FIG. 4 is a sectional view showing a principal part of FIG. 3.

First, in the case where a worker needs to see a lower portion of the vehicle body 1 so as to mount the engine, etc., as shown in FIGS. 1 and 2, the driving power of the motor 220 is respectively transmitted to the first and second rollers 231b and 232b through the first and second universal joints 241 and 242. Thereby, the first and second rollers 231b and 232b are rotated at the same speed so as to unroll the first and second vertical elastic members 231a and 232a at the same time.

At that time, the first and second exterior parts 231c and 232c expand according to an unrolling of the first and second vertical elastic members 231a and 232a. The first, second, third, and fourth supporters 261, 262, 263, and 264 also expand according to an unrolling of the first and second vertical elastic members 231a and 232a.

In addition, if a separate sensor (not shown) is provided to the system, the sensor detects the height of the worker, and the controller (not shown) controls such that the vehicle body is raised to a first predetermined height according to the detected signal.

Therefore, since the height of a lower portion of the vehicle body 1 reaches the first predetermined height (e.g., about 1700 mm˜1800 mm) with respect to the ground, the worker can smoothly perform in assembly lines in which the worker must be able to see the lower portion of the vehicle, such as a chassis line, etc.

Second, in the case where there is no need to see a lower portion of the vehicle body 1, as shown in FIGS. 3 and 4, the driving power of the motor 220 is respectively transmitted to the first and second rollers 231b and 232b through the first and second universal joints 241 and 242. Thereby, the first and second rollers 231b and 232b are rotated at the same speed, so as to roll the first and second vertical elastic members 231a and 232a at the same time.

At that time, the first and second exterior parts 231c and 232c contract according to a rolling of the first and second vertical elastic members 231a and 232a. The first, second, third, and fourth supporters 261, 262, 263, and 264 also contract according to a rolling of the first and second vertical elastic members 231a and 232a.

In addition, the sensor detects the height of the worker, and the controller (not shown) controls such that the vehicle body is lowered to a second predetermined height according to the detected signal.

Therefore, since the height of a lower portion of the vehicle body 1 reaches the second predetermined height (e.g., about 300 mm˜500 mm) with respect to the ground, the worker can smoothly perform in assembly lines in which the worker assembles an interior of the vehicle body 1, such as trim and final lines, etc.

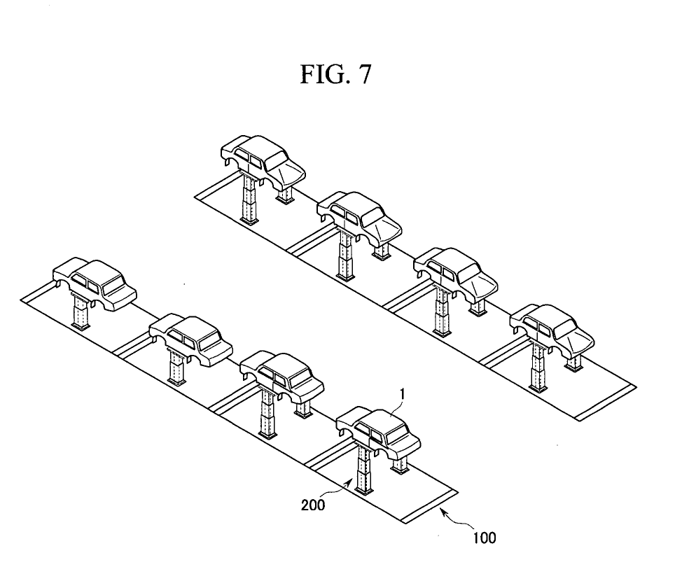

Consequently, since the system for transferring a vehicle body according to the first exemplary embodiment of the present invention is provided, as shown in FIG. 7, the vehicle body 1 is continuously transferred thereby during passing through the trim line, the chassis line, the final line, and the o.k. line.

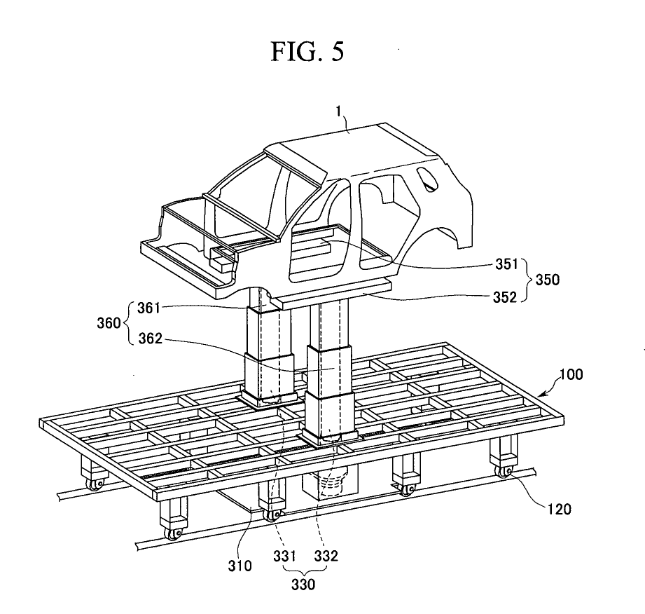

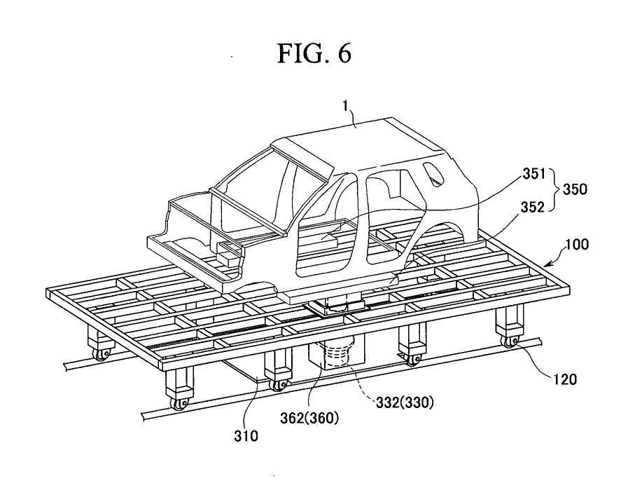

A system for transferring a vehicle body according to a second exemplary embodiment of the present invention will hereinafter be described in detail with reference to FIGS. 5 and 6

FIG. 5 is a perspective view showing a system for transferring a vehicle body according to a second exemplary embodiment of the present invention. FIG. 6 is a perspective view showing a state in which a lifter contracts, in a system for transferring a vehicle body according to the second exemplary embodiment of the present invention.

The system for transferring a vehicle body according to the second exemplary embodiment of the present invention is equal to the above-mentioned system according to the first exemplary embodiment of the present invention, except for an at least one supporter 360. Accordingly, the at least one supporter 360 will hereinafter be described in detail.

One end of the supporter 360 is mounted to a bracket 310 and the other end of the supporter 360 is mounted to a holding part 350, so as to prevent the vehicle body 1 from trembling front and rear thereof, and the supporter 360 expands and contracts according to up and down driving directions of the lifter 330.

The at least one supporter 360 includes a fifth supporter 361 which accommodates a first lifter 331 and supports a first holding part 351, and a sixth supporter 362 which accommodates the second lifter 332 and supports a second holding part 352.

In particular, the fifth and sixth supporters 361 and 362 may, as shown in FIG. 5, each be a telescopic housing in which a plurality of pipes are sequentially inserted.

As has been explained, a system for transferring a vehicle body according to an exemplary embodiment of the present invention may have the following advantages.

According to the embodiment of the present invention, since a vehicle body is continuously transferred during passing through the trim line, the chassis line, the final line, and the o.k. line, productivity can be improved.

In addition, according to the embodiment of the present invention, since there is no need to vary a type of conveyor according to each line, cost and time may be reduced.

In addition, according to the embodiment of the present invention, since there is no need to install a separate lifter between the assembly lines, cost and time may be further reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system for transferring a vehicle body, comprising:
a stage accommodating the vehicle body and transferring the vehicle body; and
a height regulating unit which is disposed on the stage and which regulates a height of the vehicle body according to a type of assembly line,
wherein the height regulating unit comprises:
a bracket disposed on a lower portion of the stage;
at least one lifter, one end of which is disposed on the bracket and the other end of which is disposed on the vehicle body, so as to raise and lower the vehicle body; and
a driving part for driving the lifter.

2. The system of claim 1, wherein:
the at least one lifter comprises first and second lifters respectively disposed on left and right sides of the vehicle body so as to prevent the vehicle body from trembling left and right, and
the driving part comprises:
a motor which is disposed on a lower surface of the stage and which drives the first and second lifters at the same time;
a first universal joint connected between the motor and the first lifter; and
a second universal joint connected between the motor and the second lifter.

3. The system of claim 2, wherein the first and second lifters respectively comprise:
first and second vertical elastic members that support the weight of the vehicle, and that are rolled at need;
first and second rollers round which the first and second vertical elastic members are respectively rolled, and that are respectively connected to the first and second universal joints; and
first and second exterior parts into which the first and second vertical elastic members are respectively inserted, and that expand and contract.

4. The system of claim 3, wherein the height regulating unit comprises first and second holding parts that are respectively mounted to an end of the first and second lifters so as to hold the vehicle body.

5. The system of claim 4, wherein the height regulating unit further comprises at least one supporter, one end of which is mounted to the bracket and the other end of which is mounted to the holding part, so as to prevent the vehicle body from trembling front and rear thereof, and the at least one supporter expands and contracts according to up and down driving directions of the lifter.

6. The system of claim 5, wherein the at least one supporter comprises:
first and second supporters that respectively support left and right sides of the first holding part with respect to the first lifter; and
third and fourth supporters that respectively support left and right sides of the second holding part with respect to the second lifter.

7. The system of claim 5, wherein the at least one supporter comprises:
a fifth supporter which accommodates the first lifter and supports the first holding part; and
a sixth supporter which accommodates the second lifter and supports the second holding part.

8. The system of claim 5, wherein the supporter is a telescopic housing in which a plurality of pipes are sequentially inserted.
